(19) United States
(12) Patent Application Publication
(10) Pub. No.: US 2006/0062611 A1
(43) Pub. Date: Mar. 23, 2006

(54) Fixing method and fixing device

(75) Inventor: Chikashi Ohishi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/229,303

(22) Filed: Sep. 19, 2005

(30) Foreign Application Priority Data
Sep. 17, 2004 (JP) 2004-271553

(51) Int. Cl. G03G 15/20

(52) U.S. Cl. 399/328

(57) ABSTRACT

The fixing method and device fix an image drawn on a recording medium using colorant particles containing at least a colorant and a resin on the recording medium. The method and device use a fixing roll pair composed of a pair of fixing rolls at least one of which is a heating roll, charge at least one of the recording medium and a sticking member for fastening the recording medium, attract electrostatically the recording medium and the sticking member and nip the recording medium and the sticking member attracted each other between the pair of fixing rolls of the fixing roll pair and convey the recording medium with the image drawn thereon together with the sticking member by means of the fixing roll pair, thereby fixing the image on the recording medium.

### BACKGROUND OF THE INVENTION

The present invention relates to a fixing method and a fixing device for fixing an image, which is drawn or recorded on a recording medium using colorant particles containing at least a colorant and a resin, on the recording medium.

As a fixing device for fixing on a recording medium, recorded on the recording medium by a recording method relying on any of various kinds of ink jet recording systems such as an electrostatic system, a piezoelectric system, and a thermal system, or an electrophotographic system, in which the image is recorded on the recording medium using colorant particles containing at least a colorant and a resin, there is a fixing device for nipping and conveying a recording medium with an image recorded thereon, using a pair of fixing rolls composed of a heating roll and a fixing roll, thereby fixing the image on the recording medium with the actions of heat and pressure.

In order to prevent colorant particles forming an image portion from adhering to the surface of the fixing roll pair during image fixation, the above-mentioned fixing device is known to have a release agent applying unit that uniformly applies a release agent to the surface of one roll of a fixing roll pair via an oil roll that rotates in contact with the other roll (hereinafter, referred to as a fixing roll) of the fixing roll pair.

For example, JP 2003-241448 A discloses a heat roll fixing device (fixing device) including a fixing roll as a rotator for fixing provided so as to rotate freely, a pressing roll that rotates while in contact with the fixing roll under pressure, an oil applying unit that is means for applying a release agent, and a roll cleaning unit.

In the heat roll fixing device, a roll cleaning unit and an oil applying unit are attached in contact with the fixing roll. The roll cleaning unit cleans the fixing roll to remove toner and the like adhered thereto, and the oil applying unit applies a release agent such as silicone oil to the fixing roll, thereby facilitating the separation of transfer paper from the fixing roll and also preventing toner from attaching to the roll cleaning unit.

JP 2001-125416 A discloses a fixing device having a release agent supply unit in which, in order to prevent a fixing roll, an oil roll, and a release agent from being charged, the surface of the oil roll that rotates in contact with the fixing roll and applies the release agent to the surface of the fixing roll is composed of a conductive material, and the surface of the oil roll is electrically grounded.

In the fixing device disclosed in JP 2003-241448 A, the recording medium is expected to be prevented from adhering to the fixing roll during fixation by applying a release agent such as silicone oil to the surface of the fixing roll. However, depending upon the kind of a recording medium on which an image is fixed, in particular, in the case of fixing an image formed on thin paper, even when the release agent is applied to the surface of the fixing roll, the recording medium adheres to the fixing roll, which may cause jamming.

In particular, in an electrostatic ink jet recording apparatus, an average particle size of colorant particles used for recording an image is about 1 μm, which is smaller than the particle size of toner particles used for an ordinary electrophotographic system. In the case of allowing a completed image to have surface glossiness, the image is flatten by bringing the surface of the fixing roll into intimate contact with the image, so that the adhesion between the surface of the fixing roll and the image increases, which is likely to cause winding of the recording medium around the surface of the fixing roll.

### SUMMARY OF THE INVENTION

An object of the present invention is to solve the above-mentioned problems, and to provide a fixing method and a fixing device capable of preventing the winding of a recording medium on which an image is fixed around a fixing roll irrespective of the kind of the recording medium.

In order to achieve the above-mentioned object, a first aspect of the present invention is to provide a fixing method for fixing an image drawn (recorded) on a recording medium using colorant particles containing at least a colorant and a resin on the recording medium, comprising: using a fixing roll pair composed of a pair of fixing rolls at least one of which is a heating roll; charging at least one of the recording medium and a sticking member for fastening the recording medium; electrostatically attracting the recording medium and the sticking member; and nipping the recording medium and the sticking member attracted each other between the pair of fixing rolls of the fixing roll pair and conveying the recording medium with the image drawn thereon together with the sticking member by means of the fixing roll pair, thereby fixing the image on the recording medium.

It is preferable that the fixing method further comprises: applying a release agent to a surface of a fixing roll of the fixing roll pair, which comes into contact with the recording medium, and the recording medium with the image drawn thereon is nipped and conveyed together with the sticking member by the fixing roll pair, to thereby fix the image on the recording medium.

It is another preferable that the fixing method further comprises: subjecting a surface of a fixing roll of the fixing roll pair, which comes into contact with the recording medium, to electrostatic elimination, and the recording medium with the image drawn thereon is nipped and conveyed together with the sticking member by the fixing roll pair, to thereby fix the image on the recording medium.

It is further preferable that the sticking member includes an insulating layer constituting a contact surface side with respect to the recording medium, and a conductive layer provided on an opposite side of the contact surface of the insulating layer with respect to the recording medium.

It is still further preferable that the fixing method further comprises: heating the sticking member at a predetermined temperature on an upstream side of the fixing roll pair in a conveying direction of the recording medium, and the recording medium with the image drawn thereon is nipped and conveyed together with the sticking member by the fixing roll pair, to thereby fix the image on the recording medium.

Furthermore, in order to achieve the above-mentioned object, a second aspect of the present invention is to provide a fixing device for fixing an image drawn (recorded) on a recording medium using colorant particles containing at least a colorant and a resin on the recording medium, comprising: a fixing roll pair composed of a pair of fixing rolls at least one of which is a heating roll; a sticking member for fastening the recording medium; and charging means for charging at least one of the recording medium and the sticking member, wherein the sticking member and the recording medium with the image drawn thereon are electrostatically attracted, and the recording medium and the sticking member attracted each other are nipped between the pair of fixing rolls of the fixing roll pair and the recording medium is conveyed together with the sticking member by the fixing roll pair, to thereby fix the image on the recording medium.

It is preferable that the fixing device further comprises: release agent applying means for applying a release agent to a fixing roll of the fixing roll pair that comes into contact with the recording medium.

It is preferable that the fixing device further comprises: electrostatic elimination means for performing electrostatic elimination on a surface of a fixing roll of the fixing roll pair that comes into contact with the recording medium.

It is another preferable that the sticking member includes an insulating layer constituting a contact surface with respect to the recording medium and a conductive layer provided on a surface opposite to the contact surface of the insulating layer with respect to the recording medium.

It is further preferable that the image on the recording medium is drawn (recorded) by electrostatic ink jet drawing (recording) means using ink in which charged colorant particles are dispersed in a solvent, the electrostatic ink jet drawing means being provided on an upstream side in a conveying direction of the recording medium.

It is still further preferable that the fixing device further comprises: heating means for heating the sticking member at a predetermined temperature, the heating means being provided on an upstream side of the fixing roll pair in a conveying direction of the recording medium.

According to the present invention, a recording medium and a sticking member are electrostatically attracted, and the recording medium is inserted together with the sticking member in a fixing roll pair to fix an image, whereby the recording medium can be prevented from being wound around the fixing roll during fixation of an image. This enables an image to be fixed preferably without causing jamming irrespective of the kind of a recording medium.

### BRIEF DESCRIPTION OF THE DRAWINGS

FIG. 1 is a schematic view showing a configuration of a first embodiment of a fixing device of the present invention.

FIG. 2 is a schematic view showing a schematic configuration of an electrostatic ink jet recording apparatus using the fixing device of the present invention.

FIG. 3 is a schematic partial perspective view showing a schematic configuration of one embodiment of an ejection head of each color used in an ink jet head shown in FIG. 2.

FIG. 4A is a schematic cross-sectional view showing a part of the ejection head shown in FIG. 3, and FIG. 4B is a cross-sectional view taken along the line B-B of FIG. 4A.

FIGS. 5A, 5B, and 5C are views respectively taken along the lines VA-VA, VB-VB, and VC-VC of FIG. 4B.

FIG. 6 is a schematic view showing another exemplary configuration of an electrostatic ink jet recording apparatus using the fixing device of the present invention.

### DETAILED DESCRIPTION OF THE INVENTION

Hereinafter, the fixing device and the fixing method according to the present invention will be described in detail by way of preferable embodiments shown in the attached drawings.

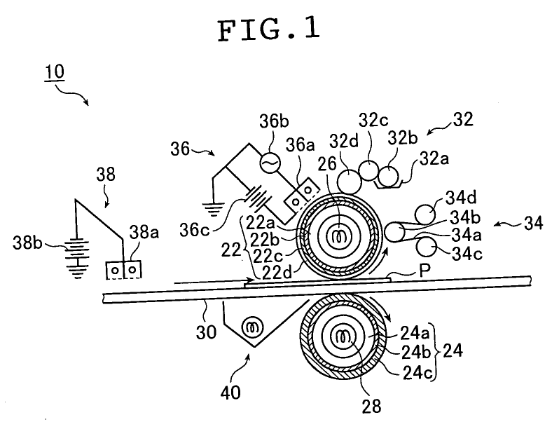

FIG. 1 is a schematic cross-sectional view showing a schematic configuration of one embodiment of a fixing device of a second aspect for performing a fixing method of a first aspect of the present invention.

A fixing device 10 shown in FIG. 1 fixes an image, which is recorded on a recording medium using colorant particles containing at least a colorant and a resin, on the recording medium. The fixing device 10 basically includes: a fixing roll pair 20 composed of a pair of fixing rolls 22 and 24 for nipping and conveying a recording medium P with an image (drawn) recorded thereon to fix the image on the recording medium P; a sticking member 30 that is nipped and conveyed by the fixing roll pair 20 (fixing rolls 22 and 24) together with the recording medium P; and charging means 38 for charging the recording medium P and/or the sticking member 30 to make them electrostatically attracted to each other. Furthermore, at the fixing roll 22 of the fixing roll pair 20, release agent applying means 32 for applying a release agent to the fixing roll 22, cleaning means 34 for cleaning the fixing roll 22, and static elimination means 36 for performing static elimination on the fixing roll 22 are provided, and heating means 40 for heating the sticking member 30 is provided so as to be opposed to the surface of the sticking member 30 on the fixing roll 24 side, on an upstream side of a conveying direction of the recording medium P with respect to the fixing roll 24.

The fixing roll 22 is placed on a side where the fixing roll 22 comes into contact with the surface of the recording medium P on which the image is recorded during fixation, and functions as a heating roll. The fixing roll 22 is a layered body in a cylindrical shape with a predetermined diameter (e.g., about 60 mm), which has a cylindrical core member 22a, an elastic layer 22b provided on the surface of the core member 22a, an intermediate layer 22c provided on the surface of the elastic layer 22b, and a coat layer 22d for enhancing the releasing property from the recording medium P, the coat layer 22d being provided on the surface of the intermediate layer 22c. Furthermore, a heater 26 is placed passing through the core member 22a substantially at an axial center on an inner side of the cylindrical core member 22a.

Herein, the core member 22a is made of cylindrical metal to be a cored bar. The elastic layer 22b is made of silicone rubber having predetermined rubber hardness, thickness, and surface roughness (e.g., rubber hardness: JIS A 10, thickness: 3 mm, surface roughness: Ra=10 μm). The intermediate layer 22c is made of fluoro rubber having predetermined rubber hardness, thickness, and surface roughness (e.g., rubber hardness: JIS A 70, thickness: 50 μm, surface roughness: Ra=0.2 μm). The coat layer 22d is made of silicone rubber having predetermined rubber hardness, thickness, and surface roughness (e.g., rubber hardness: JIS A 60, thickness: 50 μm, surface roughness: Ra=0.1 μm).

The fixing roll 24 is placed at a position opposed to the fixing roll 22 via the recording medium P, and functions as a heating roll and a pressing roll. The fixing roll 24 is also a layered body in a cylindrical shape with a predetermined diameter (e.g., about 30 to 100 mm), which has a cylindrical core member 24a, an elastic layer 24b provided on the surface of the core member 24a, and a coat layer 24c provided on the surface of the elastic layer 24b. Furthermore, a heater 28 is placed passing through the core member 24a substantially at an axial center on an inner side of the core member 24a.

Herein, the core member 24a is made of metal to be a cored bar. The elastic layer 24b is made of silicone rubber having predetermined rubber hardness and thickness (e.g., rubber hardness: JIS A 20, thickness: 2 mm). The coat layer 24c is made of resin having predetermined thickness and surface roughness (e.g., perfluoroalkoxy resin (PFA) with a thickness of 50 μm and a surface roughness Ra of 0.2 μm).

Herein, in the fixing device 10 of the present invention, the material for forming each of the fixing rolls 22 and 24 is not limited to the above, and various materials as illustrated below can be used irrespective of the conductivity and insulation property.

For example, various kinds of members having sufficient strength with respect to a pressure can be used for the core member 22a of the fixing roll 22. A member made of a material having satisfactory heat conductivity is preferable. Specific examples thereof include a roll of an aluminum material such as A5056, A5052, A5083, or A6063, and a roll made of non-magnetic stainless steel such as STKM11.

The elastic layer 22b may be formed of synthetic rubber such as silicone rubber or fluoro rubber. In particular, in the case of forming a single layer configuration, low-temperature vulcanizing (LTV) silicone rubber having an excellent releasing property with respect to the recording medium P with an image recorded thereon is preferably illustrated.

Furthermore, in order to enhance the heat conductivity during fixation by heating, it is also preferable to mix 5 to 30% by weight of powder of a metal oxide such as silica, alumina, or magnesium oxide as a filler. Furthermore, for the same reason, conductive carbon black may be used as a filler. In this case, the electrical resistance of the elastic layer can be reduced to prevent charging.

The intermediate layer 22c may be formed by mixing fluoro rubber with fluoro resin. Herein, the fixing roll may have a two-layered configuration without the intermediate layer. However, by providing the intermediate layer as in this embodiment, for example, the adhesion between the elastic layer and the coat layer can be enhanced, the damage (occurrence of cracks, etc.) of the coat layer can be prevented due to the buffer action of the intermediate layer, and the swelling of the elastic layer due to the penetration of silicone oil can be prevented.

The coat layer 22d may be formed by coating the elastic layer with a tube made of fluoro resin such as PFA as in this embodiment. Alternatively, fluoro resin coating such as PTFE, PFA, or FEP may be applied to the surface of the elastic layer to form the coat layer.

A fixing roll with a three-layered configuration is also preferable, in which high-temperature vulcanizing (HTV) silicone rubber having excellent heat resistance is used for the elastic layer, a fluoro rubber layer for preventing the swelling of the elastic layer is provided as the intermediate layer on the elastic layer, and an LTV silicone rubber layer is provided on the intermediate layer as the coat layer.

Herein, the layer configuration of the fixing roll is not limited to the above, and any layer configuration may be used. For example, a roll with a two-layered configuration can also be used in which the elastic layer and the coat layer are stacked on the surface of a cored bar without providing the intermediate layer.

On the other hand, regarding the fixing roll 24, the same materials as those for the core member, the elastic layer, and the coat layer of the fixing roll 22, and a roll with any one of the above-mentioned various kinds of layered configurations of the fixing roll 22 can be used. In the case where the fixing roll 22 or the fixing roll 24 does not have a heating source, the heat conductivity of the core member is not necessarily high. Furthermore, the fixing roll 24 may be a reverse crown roll or a crown roll.

In addition, a soft roll in which the core member is coated with a silicone rubber layer, a fluoro rubber layer, or a foaming rubber layer in a sponge shape using a foaming material such as silicone rubber can also be used preferably. Furthermore, a hard roll in which the core member is coated with fluoro resin such as PTFE, PFA, or FEP, or a PFT tube can also be suitably used.

The heaters 26 and 28 placed respectively inside the fixing rolls 22 and 24 are each a heating source such as a halogen lamp, and heat the fixing rolls 22 and 24 to a predetermined temperature during fixation of an image. Furthermore, a heater for heating a fixing roll may not be provided in each of the rolls, and may be placed either one of the fixing rolls. In the case of placing a heater in only one fixing roll, it is preferable to place the heater in the fixing roll placed on a side that comes into contact with the surface on which an image is recorded. More specifically, in the present invention, at least one of the fixing rolls 22 and 24 constituting the fixing roll pair 20 only needs to be used as a heating roll containing a heater. A heating source may also be placed in the vicinity of the surface of a roll to heat the surface of the roll directly. For example, a configuration in which a heater and a reflective plate are provided in the vicinity of the surface of the roll can be used.

Furthermore, the fixing roll pair 20 is connected to driving means (not shown), and this driving means rotates the fixing roll pair 20 in a predetermined direction. Herein, regarding the fixing roll pair 20, when one fixing roll rotates, the other fixing roll follows it, so that the driving means only needs to be provided in at least one fixing roll of the fixing roll pair 20. More specifically, at least one of the fixing rolls 22 and 24 needs only be a driving roll. Furthermore, a configuration in which both the fixing rolls 22 and 24 are driven can also be used.

The sticking member 30 is a plate-shaped member having chargeability, and nipped between the fixing rolls 22 and 24. The sticking member 30 can be moved by driving means (not shown), and moves in an arrow direction in synchronization with the rotation of the fixing roll pair 20 in this embodiment.

The sticking member 30 has a two-layered configuration in which an insulating layer and a conductive layer are stacked. The insulating layer is placed on the fixing roll 22 side, i.e., on the side on which the recording medium P comes into contact therewith, and the conductive layer is placed on the fixing roll 24 side, i.e., on the opposite side of the contact surface with the recording medium P.

The insulating layer is made of a dielectric having a thickness of 10 to 1000 μm and a specific resistance of 10¹¹ Ωm or more (e.g., any one of various kinds of plastics such as polyimide resin or fluoro resin, or high-purity wood paper). Herein, an example of plastic includes fluoro resin, and more specific examples include polytetrafluoroethylene (PTFE), tetrafluoroethylene-perfluoroalkoxyethylene copolymer (PFA), tetrafluoroethylene-hexa fluoropropylene copolymer (FEP), tetrafluoroethylene-ethylene copolymer (ETFE), polychlorotrifluoroethylene (PCTFE), polychlorotrifluoroethylene-ethylene copolymer (ECTFE), polyvinylidene fluoride (PVDF), and polyvinyl fluoride (PVF).

Herein, it is preferable that the thickness of the insulating layer be 10 μm to 500 μm, and the average surface roughness Ra satisfy Ra≦20 μm.

The conductive layer is configured by attaching a coating film, a vapor-deposited film, or a thin film containing a conductor with a specific resistance of 10⁸ Ωcm or less (e.g., various kinds of metals such as iron, aluminum, copper, and stainless steel), or a conductive material such as an alloy, carbon black, or metal powder. The potential of the conductive layer is held at a reference potential of 0 V by a ground member (not shown).

The insulating layer and the conductive layer are stacked, the conductive layer is grounded, and charge is accumulated on the surface from the insulating layer side by charging means 38 described later. Consequently, when the recording medium P is placed on the surface of the insulating layer, dielectric polarization occurs in the medium, and the medium is electrostatically attracted to the sticking member 30.

Herein, the configuration of the sticking member 30 is not limited to the above, and even when the sticking member 30 is composed of only the insulating layer, the surface of the sticking member can be charged. Herein, an example of an insulating member includes fluoro resin. Examples of the fluoro resin include polytetrafluoroethylene (PTFE), tetrafluoroethylene-perfluoroalkoxyethylene copolymer (PFA), tetrafluoroethylene-hexa fluoropropylene copolymer (FEP), tetrafluoroethylene-ethylene copolymer (ETFE), polychlorotrifluoroethylene (PCTFE), polychlorotrifluoroethylene-ethylene copolymer (ECTFE), polyvinylidene fluoride (PVDF), and polyvinyl fluoride (PVF). By using those materials, the charge holding property and durability of the sticking member 30 can be enhanced.

The charging means 38 is placed on an upstream side (left side of FIG. 1) of the fixing roll pair 20 in the conveying direction of the recording medium P, and includes a corotron charger 38a and a high-voltage power source 38b. The corotron charger 38a is placed at a position opposed to the sticking member 30 on an upstream side of the fixing roll pair 20 in the conveying direction of the recording medium P. Furthermore, the corotron charger 38a is connected to a terminal on a negative side of the high-voltage power source 38b, and a terminal on a positive side of the high-voltage power source 38b is grounded.

The charging means 38 uniformly charges the sticking member 30 at a predetermined potential by means of the corotron charger 38a connected to the high-voltage power source 38b.

Herein, in this embodiment, the corotron charger is used as charging means. However, the present invention is not limited thereto, and various charging means such as a scorotron charger, a solid-state charger, and a discharge needle can be used.

According to a preferable mode, in the fixing device 10 of this embodiment, the release agent applying means 32, the cleaning means 34, and the static elimination means 36 are provided.

The release agent applying means 32 includes an oil tank 32a for storing a release agent L, pumping rolls 32b and 32c for pumping up silicone oil from the oil tank 32a, and a coating roll 32d for coating the fixing roll 22 with the release agent L from the pumping rolls 32b and 32c.

The oil tank 32a is placed at a predetermined distance from the fixing roll 22, and stores a predetermined amount of the release agent L. Herein, as the release agent L, silicone oil is most preferable. For example, dimethylsiloxane, dimethylsiloxane containing an amino group, organopolysiloxane, dimethylorganopolysiloxane, or the like can be used alone or in an appropriate combination thereof, with a kinematic viscosity being set to be about 100 to 1000 cSt.

The pumping roll 32b is provided with a member which is impregnated with the release agent L on at least the surface thereof, and is placed so as to be soaked in the release agent L stored in the oil tank 32a. Furthermore, the pumping roll 32c is a rotatable roll, and placed in contact with the pumping roll 32b. The pumping roll 32c rotates in contact with the pumping roll 32b, whereby the surface thereof is coated with the release agent L.

The coating roll 32d is a rotatable roll obtained by covering the surface of sponge rubber with silicone rubber, and is placed in contact with the fixing roll 22 and the pumping roll 32c. The coating roll 32d rotates in contact with the fixing roll 22 and the pumping roll 32c. Because of this, the release agent L applied to the surface of the pumping roll 32c is applied to the surface of the coating roll 32d, and the release agent L applied to the surface of the coating roll 32d is applied to the surface of the fixing roll 22.

Thus, the surface of the fixing roll 22 is coated with the release agent, whereby the releasing property between the fixing roll 22 and the recording medium P can be enhanced, and the winding of the recording medium P around the fixing roll 22 can be prevented reliably. Furthermore, toner in an image portion formed on the recording medium P can be advantageously prevented from adhering to the fixing roll 22 during fixation.

Herein, the shape and configuration of the oil applying means are not limited to the above. For example, a blade for controlling the coating amount of oil from the coating roll may be further provided. Furthermore, according to another mode, the following may be possible. A felt-like member impregnated with a release agent is brought into contact with the fixing roll, and the fixing roll is rotated in a sliding contact with the felt-like member, whereby the fixing roll is coated with the release agent.

The cleaning means 34 cleans the fixing roll 22 to remove toner adhered thereto, and is provided on an upstream side in the rotation direction of the fixing roll 22 with respect to the release agent applying means 32. Therefore, the surface of the fixing roll 22 is cleaned by the cleaning means 34, and then the release agent L is applied to the cleaned surface of the fixing roll 22 by the release agent applying means 32. The cleaning means 34 is composed of: a cleaning web 34a made of a band-shaped heat-resistant non-woven fabric; a pressing roll 34b for pressing the cleaning web 34a against the fixing roll 22; a sending roll 34c for sending the cleaning web 34a on which the toner or the like is not adhered; and a taking-up roll 34d for gradually taking up the cleaning web 34a whose cleaning ability has decreased owing to the toner and the like adhering thereto.

Using the above-mentioned cleaning means 34, the cleaning web 34a is pressed against the fixing roll 22 by the pressing roll 34b and the fixing roll 22 is rotated in a sliding contact with the cleaning web 34a, whereby toner and dirt adhering to the surface of the fixing roll can be removed.

Furthermore, by providing the cleaning means 34 on an upstream side in the rotation direction of the fixing roll 22 with respect to the release agent applying means 32, toner adhering to the surface of the fixing roll 22 can be prevented from adhering to the coating roll 32d to make it dirty.

Herein, the cleaning means 34 is not limited to this embodiment, and various cleaning means can be used.

The static elimination means 36 includes a scorotron charger 36a for performing static elimination on the fixing roll 22, an AC voltage source 36b, and a fixing roll surface potential control power source 36c.

The scorotron charger 36a is provided at a position opposed to the fixing roll 22 on a downstream side in the rotation direction of the fixing roll 22 with respect to the cleaning means 34. The scorotron charger 36a is connected to the AC voltage source 36b and the fixing roll surface potential control power source 36c, and the other ends of the AC voltage source 36b and the fixing roll surface potential control power source 36c are respectively grounded.

The scorotron charger 36a controls a grid voltage to perform static elimination on the surface of the fixing roll 22, whereby the potential of the surface of the fixing roll 22 can be set to be substantially 0.

This can achieve static elimination of the fixing roll 22, and the minus charge is not accumulated on the surface of the fixing roll 22 owing to the separation charging between the fixing roll 22 and the recording medium P during fixation. Thus, the recording medium P can be prevented from being easily wound around the fixing roll 22 with an electrostatic force due to charges gradually accumulated on the surface of the fixing roll 22.

Herein, in this embodiment, the scorotron charger is used as the static elimination means. The present invention is not limited thereto, and various static elimination means such as a corotron charger, a solid-state charger, and a discharge needle can be used.

The heating means 40 heats the sticking member 30 to a predetermined temperature, and is provided at a position opposed to the surface of the sticking member 30 on the fixing roll 24 side, and on an upstream side in the conveying direction of the recording medium P with respect to the fixing roll 24. The heating means 40 is composed of a halogen lamp heater and a reflective plate.

The heating means 40 heats the sticking member 30 to which the recording medium P before fixation of an image by the fixing roll pair 20 is attached, to a predetermined temperature.

Accordingly, by heating the sticking member 30 with the heating means 40, the conveying speed of the recording medium P increases, and even in the case where the sticking member 30 cannot be heated sufficiently by heating with the heaters 26 and 28, the sticking member 30 can be heated to a predetermined temperature, whereby fixation by the fixing roll pair 20 can be performed preferably. Furthermore, by providing the heating means 40 to heat the sticking member 30, the heaters 26 and 28 can be set to heat the sticking member 30 to a predetermined temperature or lower. Consequently, the following can be prevented: the temperature of each of the fixing rolls 22 and 24 becomes too high, thereby wearing away each layer of the fixing rolls 22 and 24 (in particular, the elastic layer), with the result that durability degrades.

Furthermore, the heating means 40 is not limited to this embodiment, and various heating means can be used.

Next, the function of the fixing device 10 will be described.

First, the surface of the sticking member 30 on an insulating layer side is charged to a predetermined potential by the charging means 38.

Next, on the charged sticking member 30, the recording medium P having an image portion where an image is recorded (drawn) using colorant particles containing at least resin but is not fixed is placed. Herein, as described above, the surface of the sticking member 30 is charged, so that the recording medium P and the sticking member 30 electrostatically attract each other, whereby the recording medium P sticks to the sticking member 30.

Next, the sticking member 30 starts moving in the direction of the fixing roll pair 20. The recording medium P electrostatically attracted to the sticking member 30 is guided between the fixing rolls 22 and 24 together with the sticking member 30. Herein, the surfaces of the fixing rolls 22 and 24 of the fixing roll pair 20 are heated to, for example, 80° C. with the heaters 26 and 28.

The recording medium P and the sticking member 30 are nipped and conveyed by the fixing rolls 22 and 24 to be heated and pressed, whereby an image is fixed on the recording medium P. The recording medium P with the image fixed thereon is discharged from the fixing device 10.

As described above, using the sticking member 30, the recording medium P and the sticking member 30 are allowed to electrostatically attract each other, and the recording medium P is nipped and conveyed together with the sticking member 30 in a state in which the recording medium P sticks to the sticking member 30 thereby fixing an image. The image can be thus fixed on the recording medium P without the winding of the recording medium P around the fixing roll 22.

Because of the above, jamming that occurs owing to the winding of the recording medium around the fixing roll 22 during fixation of an image can be prevented, and an image can be fixed preferably.

Herein, it is preferable that the entire surface of the recording medium P be electrostatically attracted to the sticking member 30 as in this embodiment. However, the present invention is not limited thereto, and only a part of the recording medium may also be allowed to be electrostatically attracted to the sticking member to fix an image.

Furthermore, by coating the fixing roll 22 with a release agent by means of the release agent applying means 32, the releasing property between the recording medium P and the fixing roll 22 is enhanced, and the winding of the recording medium P around the fixing roll 22 can be prevented reliably.

Furthermore, by performing static elimination on the surface of the fixing roll 22 by means of the static elimination means 36, the winding of the recording medium P around the fixing roll due to separation charging or the like can be prevented, which can prevent the occurrence of jamming more reliably.

Herein, in the above embodiment, the recording medium P is placed on the charged sticking member 30, whereby the sticking member 30 and the recording medium P are allowed to electrostatically attract each other. Even if the surface of the recording medium P is charged after the recording medium P is placed on the sticking member 30, the sticking member 30 and the recording medium P can electrostatically attract each other.

Furthermore, the shape and conveyance form of the sticking member are not particularly limited. The following may be possible. The sticking member formed into a sheet shape is allowed to pass the fixing roll pair after the recording medium is electrostatically attracted thereto to fix an image, and the sticking member is moved in an opposite direction (reciprocated) after the recording medium is removed. Alternatively, the following may be possible. The sticking member is formed in an endless belt shape, and the electrostatic attraction of the recording medium, the fixation of a recorded image and the removal of the recording medium are performed while the sticking member rotates in a predetermined direction.

Next, an example of an image recording apparatus using the fixing device of the present invention will be described.

The fixing device of the present invention can form an image finished with a sharpness on a recording medium, using fixing means thereof, and can further prevent paper jamming in the fixing means, in various kinds of image recording apparatuses for recording an image using ink containing colorant particles that contain at least a colorant and a resin. For example, the fixing device of the present invention is applicable to ink jet recording apparatuses of various kinds of systems using the above colorant particles and an electrophotographic recording apparatus. Hereinafter, a preferable example using an electrostatic ink jet recording apparatus capable of recording an image of high quality will be described.

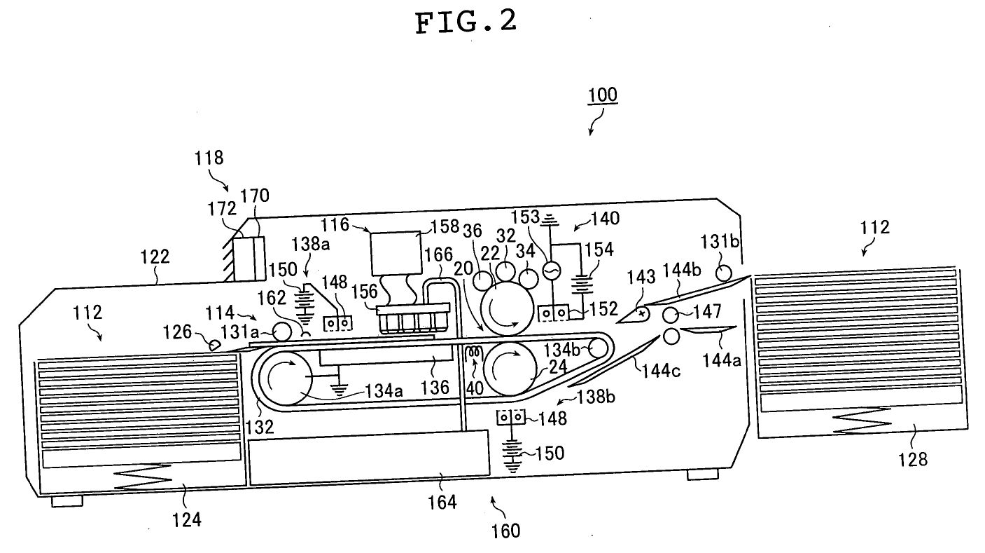

FIG. 2 is a schematic view showing a schematic configuration of an electrostatic ink jet recording apparatus 100 using the fixing device 10 of the present invention. The electrostatic ink jet recording apparatus 100 shown in FIG. 2 uses ink (ink composition) in which charged fine particles containing a colorant (hereinafter, referred to as colorant particles) are dispersed in an insulating solvent (carrier liquid), and the apparatus applies an electrostatic force to ink to eject it (liquid droplets). The electrostatic ink jet recording apparatus 100 ejects ink of four colors (C (cyan), M (magenta), Y (yellow), and K (black)) by means of an ejection head corresponding to each color in accordance with supplied image data, thereby recording a full-color image of four colors. Furthermore, the apparatus shown in FIG. 2 can also record an image on both surfaces of the recording medium (recording sheet) P if required.

The electrostatic ink jet recording apparatus 100 (hereinafter, referred to as the recording apparatus 100) includes holding means 112 of the recording medium P, conveying means 114, recording means 116, solvent collecting means 118, and a housing 122. Herein, the fixing device of the present invention is provided in the conveying means 114.

First, the holding means 112 of the recording medium P includes a sheet feed tray 124 for holding the recording medium P before recording, a feed roll 126, and a discharge tray 128 for holding the recording medium P after recording.

The sheet feed tray 124 is loaded detachably in a predetermined loading part on a bottom surface on the left side in FIG. 2 inside the housing 122 in a state in which the tray 124 contains a number of unrecorded sheets of the recording medium P.

The feed roll 126 is placed corresponding to a take-out side end portion of the sheet feed tray 124 loaded in the loading part, and supplies one sheet of the recording medium P to the conveying means 114 in accordance with an instruction of the commencement of recording.

On the other hand, the discharge tray 128 is loaded detachably in a predetermined loading part on the right side in FIG. 2 outside the housing 122.

The recording medium P after recording is conveyed by the conveying means 114 and discharged from a discharge part to the discharge tray 128.

Next, the conveying means 114 of the recording medium P will be described.

The conveying means 114 conveys the recording medium P in a predetermined path from the sheet feed tray 124 to the discharge tray 128, and includes conveyor rolls 131a and 131b, a conveyor belt 132, belt rolls 134a and 134b, the heating means 40, a conductive platen 136, charging devices 138a and 138b of the recording medium P, a static elimination device 140 of the recording medium P, a switching claw 143, guides 144a, 144b, and 144c, an inversion roll pair 147, and the fixing roll pair 20.

The conveyor roll 131a is provided at a position between the feed roll 126 and the recording means 116 on the conveying path of the recording medium P.

The recording medium P taken out by the feed roll 126 from the sheet feed tray 124 is nipped and conveyed by the conveyor roll 131a and the conveyor belt 132 in the right-side direction in FIG. 2.

The charging device 138a of the recording medium P includes a scorotron charger 148 and a high-voltage power source 150. The charging device 138a is placed at a position between the conveyor roll 131a and the recording means 116 on the conveying path of the recording medium P. Furthermore, a terminal on a negative side of the high-voltage power source 150 is connected to the scorotron charger 148, and a terminal on a positive side thereof is grounded.

The surface of the recording medium P is charged uniformly to a predetermined negative high potential by the scorotron charger 148 connected to the high-voltage power source 150, and is always supplied with a constant DC bias voltage (e.g., about −1.5 kV). By applying the bias voltage to the recording medium P, the recording medium P is allowed to act as a counter electrode, and a driving voltage (pulse voltage) applied to a control electrode (ejection electrode) described later can be reduced. Furthermore, by the application of the bias voltage, the recording medium P is electrostatically attracted to the surface (having insulation property) of the conveyor belt 132.

The conveyor belt 132 is an endless belt, and is stretched in an oval shape around two belt rolls 134a and 134b. In the conveyor belt 132, a surface (outer surface) that electrostatically attracts the recording medium P is insulative, and a reverse surface (inner surface) thereof is conductive.

Furthermore, on an inner side of the conveyor belt 132 positioned opposed to the recording means 116, the plate-shaped conductive platen 136 is placed.

The belt rolls 134a and 134b, and the conductive platen 136 are grounded, and hence the reverse surface of the conveyor belt 132 is also grounded via the belt rolls 134a and 134b, and the conductive platen 136.

One of the belt rolls 134a and 134b is connected to a driving source (not shown), and is rotated at a predetermined speed during recording. Because of this, the conveyor belt 132 rotates in a clockwise direction in FIG. 2, and the recording medium P electrically attracted to the conveyor belt 132 is also conveyed in the same direction.

Thus, in this embodiment, in order to reduce a driving voltage, the recording medium P is charged to a predetermined potential by the charging device 138a, and the recording medium P is electrostatically attracted to the conveyor belt 132. Because of this, in this embodiment, the charging device 138a has a function of charging means, and the conveyor belt 132 has a function of a sticking member.

The fixing roll pair 20 has the fixing rolls 22 and 24, and is placed between the recording means 116 and the belt roll 134b on the conveying path of the recording medium P. The fixing rolls 22 and 24 are placed at positions opposed to each other via the conveyor belt 132. That is, the conveyor belt 132 is nipped between the fixing rolls 22 and 24. The recording medium P is nipped and conveyed by the fixing roll pair 20 while being electrostatically attracted to the conveyor belt 132, and a recorded image is fixed on the recording medium P. Furthermore, the release agent applying means 32, the cleaning means 34, and the static elimination means 36 are placed in contact with the fixing roll 22.

The heating means 40 is placed at a position between the recording means 116 and the fixing roll pair 20 on the conveying path of the recording medium P, and on the conductive platen 136 side on an inner side of the conveyor belt 132. The heating means 40 heats the conveyor belt 132 to a predetermined temperature before an image is fixed on the recording medium P by the fixing roll pair 20.

Furthermore, the static elimination device 140 of the recording medium P includes a scorotron charger 152, an AC voltage source 153, and a high-voltage power source 154. The static elimination device 140 is placed at a position that is between the fixing roll pair 20 and the belt roll 134b on the conveying path of the recording medium P and opposed to the surface of the conveyor belt 132. The scorotron charger 152 is connected to the AC voltage source 153 and the high-voltage power source 154, and other ends of the AC voltage source 153 and the high-voltage power source 154 are respectively grounded.

The recording medium P after recording is subjected to static elimination by the scorotron charger 152 connected to the AC power source 153 and the high-voltage power source 154. Because of this, the attracting force caused by the electrostatic force acting between the recording medium P and the conveyor belt 132 is removed, whereby the recording medium P can be separated from the conveyor belt 132 easily.

The switching claw 143, the inversion roll pair 147, and the guide 144a are placed in this order on a downstream side of the static elimination device 140 on the conveying path of the recording medium P.

The guide 144b and the conveyor roll 131b are placed between the switching claw 143 and the discharge tray 128 on the conveying path during conveyance, and the guide 144c is placed between the inversion roll pair 147 and the charging device 138b on the conveying path during inversion of the recording medium P.

In the case where recording on both surfaces is instructed, the switching claw 143 is set at an inverted position after recording on one surface, and the recording medium P with one surface recorded is conveyed to the inversion roll pair 147 side. When a leading edge of the recording medium P is nipped and conveyed by the inversion roll pair 147 and mounted on the guide 144a, and a trailing edge thereof leaves the conveyor belt 132, the trailing edge is placed on the guide 144c. At this timing, the rotation of the inversion roll pair 147 is reversed, and the recording medium P is nipped and conveyed between the conveyor belt 132 and the guide 144c, whereby the recording medium P is supplied to a predetermined position on the conveyor belt 132 along the guide 144c.

After recording in the case where recording on only one surface is instructed, and after recording on both surfaces in the case where recording on both surfaces is instructed, the switching claw 143 is set at a discharge position, and the recording medium P after recording is supplied to the guide 144b side. Then, the recording medium P is conveyed by the conveyor belt 132 along the guide 144b, further nipped and conveyed between the conveyor roll 131b and the guide 144b, discharged from the discharge part and, successively stacked and thus stocked in the discharge tray 128.

The charging device 138b for the recording medium P has the same configuration as that of the charging device 138a, and is placed at a position on a downstream side of the guide 144c on the conveying path during inversion of the recording medium P, more specifically, at a position opposed to the surface of the conveyor belt 132 after conveyance of the recording medium P by the inversion roll pair 147.

The surface of the recording medium P supplied to a predetermined position on the conveyor belt 132 along the guide 144c is charged by the charging device 138b, and the recording medium P is electrostatically attracted to the surface having insulation property of the conveyor belt 132 again. Then, the recording medium P electrostatically attracted to the conveyor belt 132 is moved in synchronization with the movement of the conveyor belt 132, and nipped and conveyed between the conveyor roll 131a and the conveyor belt 132 again, whereby an image is recorded on a reverse surface side.

Next, the recording means 116 of the recording medium P will be described.

The recording means 116 records a full-color image by printing four colors on the recording medium P by an electrostatic ink jet system, and includes an ink jet head 156, a head driver 158, an ink circulation system 160, and a position detecting device 162 of the recording medium P.

The ink jet head 156 is a line head capable of recording an image of one line simultaneously, and includes ejection heads of four colors (cyan (C), magenta (M), yellow (Y), and black (K)) for recording a full-color image.

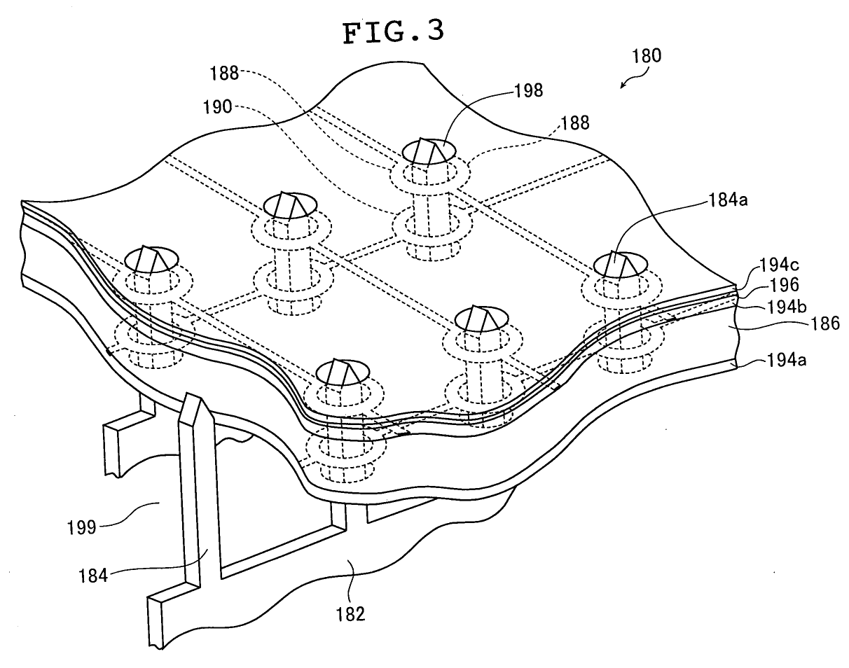

FIGS. 3, 4A-4B, and 5A-5C each shows a specific head configuration of the ejection head of each color of the electrostatic ink jet head 156 that ejects ink in which the above-mentioned colorant particles (charged fine particles containing a colorant) are dispersed in a carrier liquid, with an electrostatic force.

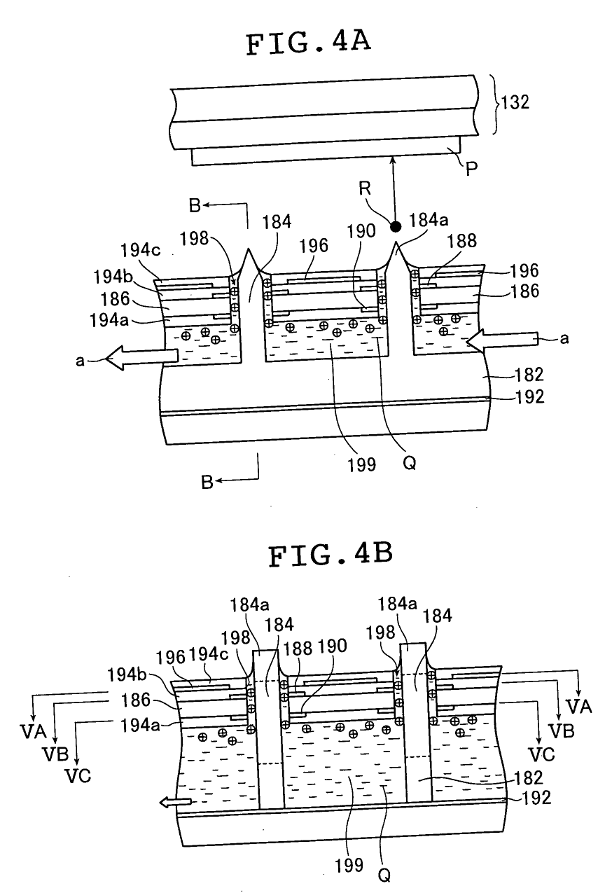

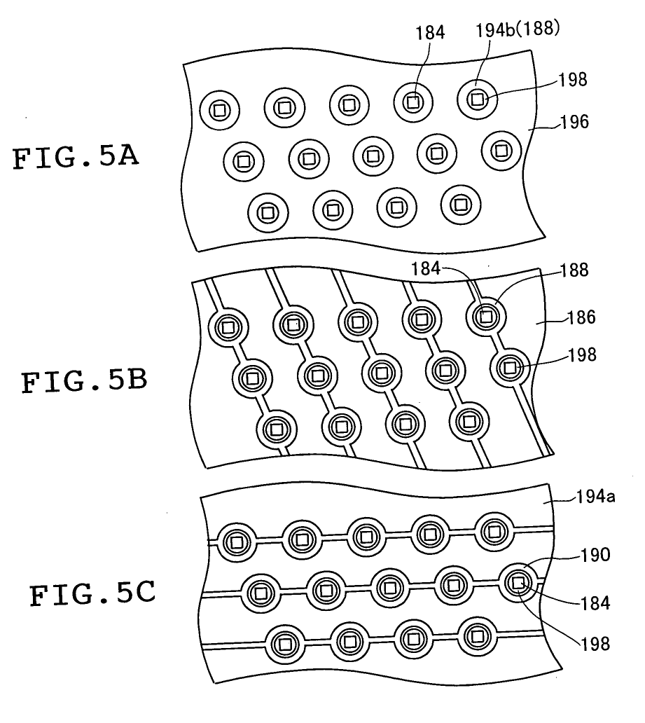

FIG. 3 is a partial perspective view schematically showing a construction of an example of an ejection head 180 for each color used in the ink jet head 156 shown in FIG. 2. FIG. 4A is a schematic cross-sectional view showing a part of the ejection head 180 shown in FIG. 3. FIG. 4B is a schematic cross-sectional view taken along line B-B in FIG. 4A. FIGS. 5A, 5B, and 5C are cross-sectional views taken along the line VA-VA, the line VB-VB, and the line VC-VC in FIG. 4B.

The ejection head 180 shown in these figures is an electrostatic ink jet head having control electrodes of a two-layered electrode structure and records an image corresponding to image data on the recording medium P by ejecting ink Q containing colorant particles, such as charged pigments (fine particle component of toner or the like, for instance), by means of an electrostatic force. For this purpose, the ejection head 180 includes a head substrate 182, ink guides 184, an insulating substrate 186, first control electrodes 188 and second control electrodes 190 composing control electrodes, and a floating conduction plate 192. The ejection head 180 having this construction is arranged so as to be opposed to the conveyor belt 132 that supports the recording medium P and serves as a counter electrode.

In the ejection head 180 of the illustrated embodiment, the control electrodes form a two-layered electrode structure having the first control electrodes 188 arranged on the upper surface of the insulating substrate 186 and the second control electrodes 190 arranged on the lower surface thereof in FIGS. 4A and 4B so as to sandwich the insulating substrate 186 therebetween.

The ejection head 180 of the illustrated embodiment also includes an insulation layer 194a covering the lower side (lower surfaces) of the second control electrodes 190, an insulation layer 194b covering the upper side (upper surfaces) of the first control electrodes 188, a sheet-like guard electrode 196 arranged on the upper side of the first control electrodes 188 with the insulation layer 194b in between, and an insulation layer 194c covering the upper surface of the guard electrode 196.

In the ejection head 180 of the illustrate embodiment, each ink guide 184 is made of an insulating resin flat plate having a predetermined thickness and having a projection-like tip end portion 184a, and each ink guide 184 is arranged on the head substrate 182 at the position of each ejection portion. Further, in a layered product of the insulation layer 194a, the insulating substrate 186, and the insulation layers 194b and 194c, through holes 198 are established at positions corresponding to the arrangement of the ink guides 184. The ink guides 184 are inserted into the through holes 198 from the insulation layer 194a side so that the tip end portions 184a of the ink guides 184 project from the insulation layer 194c. Note that a slit serving as an ink guide groove may be formed in the tip end portion 184a of each ink guide 184 in the top-bottom direction in FIG. 4A, thereby promoting supply of the ink Q and concentration of the colorant particles in the ink Q in the tip end portion 184a.

The tip end portion 184a of each ink guide 184 is formed in an approximately triangular shape (or an approximately trapezoidal shape) that is gradually narrowed toward the recording medium P (conveyor belt 132) side. Also, it is preferable that a metal be vapor-deposited on the tip end portion (extreme tip end portion) 184a of each ink guide 184 from which the ink Q is to be ejected. Although there occurs no problem even if the metal vapor-deposition is not carried out for the tip end portion 184a of the ink guide 184, it is preferable that the metal vapor-deposition be conducted because the effective dielectric constant of the tip end portion 184a of the ink guide 184 becomes substantially large as a result of the metal vapor-deposition and there is provided an effect that it becomes easy to generate an intense electric field. Note that the shape of the ink guides 184 is not specifically limited so long as it is possible to concentrate the ink Q (in particular, the colorant particles in the ink Q) in the tip end portions 184a through the through holes 198 of the insulating substrate 186. For instance, the shape of the tip end portions 184a may be changed as appropriate into a shape other than the projection, such as a conventionally known shape.

The head substrate 182 and the insulation layer 194a are arranged so as to be spaced apart from each other by a predetermined distance, and an ink flow path 199 functioning as an ink reservoir (ink chamber) for supplying the ink Q to the ink guides 184 is formed between the head substrate 182 and the insulation layer 194a. Note that the ink Q in the ink flow path 199 contains colorant particles charged to the same polarity as the voltages applied to the first control electrodes 188 and the second control electrodes 190, and is circulated in a predetermined direction (in the embodiment shown in FIG. 4A, in the direction of an arrow “a” from the right to the left) in the ink flow path 199 at a predetermined speed (at an ink flow rate of 200 mm/s, for instance) by the ink circulation system 160 (see FIG. 2) at the time of recording. Hereinafter, a case where the colorant particles in the ink are positively charged will be described as an example.

As shown in FIG. 3, the first control electrodes 188 and the second control electrodes 190 are arranged in a ring shape for the respective ejection portions on the upper surface of the insulating substrate 186 (on the recording medium P side) and the lower surface thereof (on the head substrate 182 side), respectively, and they are circular electrodes surrounding the through holes 198 bored in the insulating substrate 186. Note that the first control electrodes 188 and the second control electrodes 190 are not limited to the circular electrodes and may be changed into approximately circular electrodes, division-circular electrodes, parallel electrodes, or approximately parallel electrodes. The first control electrodes 188 and the second control electrodes 190 are arranged in a matrix shape and form the two-layered electrode structure. Here, the multiple first control electrodes 188 are connected to each other in a row direction (main scanning direction, for instance) and the multiple second control electrodes 190 are connected to each other in a column direction (sub scanning direction, for instance).

When the first control electrodes 188 in one row are set at a high-voltage level or under a floating (high-impedance) state and the second control electrodes 190 in one column are set at a high-voltage level, that is, when both of one row and one column of the electrodes are set under an on-state, one ejection portion existing at an intersection of the row and the column is set under an on-state and ejects the ink. Note that ink ejection is not performed when one of the first control electrodes 188 and the second control electrodes 190 are set at a ground level. In this manner, the first control electrodes 188 and the second control electrodes 190 arranged in a matrix manner are matrix-driven. Therefore, the number of head drivers 158 (refer to FIG. 2) for driving the first and second control electrodes 188 and 190 can be significantly reduced, which ensures a more compact configuration of the head drivers 158 and reduction of the surface area where the head drivers 158 are mounted.

Meanwhile, the recording medium P charged to a bias voltage having a polarity that is opposite to the polarity of the charged colorant particles in the ink is arranged so as to be opposed to the ink guides 184 while being held on the conveyor belt 132. As described above, in this embodiment, the recording medium P is charged to a negative high voltage. Also, the front surface of the conveyor belt 132 holding the recording medium P has an insulating layer and the back surface thereof has a conductive layer, with the conductive layer being grounded through the conductive belt roller 134b (see FIG. 2).

The floating conduction plate 192 is arranged below the ink flow path 199 and is set under an electrically insulated state (high-impedance state). In the illustrated embodiment, the floating conduction plate 192 is arranged inside the head substrate 182.

At the time of recording of an image, the floating conduction plate 192 generates an induced voltage in accordance with the value of a voltage applied to each ejection portion and causes the colorant particles in the ink Q in the ink flow path 199 to migrate to the insulating substrate 186 side and to be concentrated. Accordingly, it is required that the floating conduction plate 192 be arranged on the head substrate 182 side with respect to the ink flow path 199. Also, it is preferable that the floating conduction plate 192 be arranged on an upstream side of the ink flow path 199 with respect to the position of the ejection portion. With this floating conduction plate 192, the concentration of the colorant particles in the upper layer in the ink flow path 199 is increased. As a result, it becomes possible to increase the concentration of the colorant particles in the ink Q passing through the through holes 198 formed in the insulating substrate 186 to a predetermined level, to cause the colorant particles to be concentrated in the tip end portions 184a of the ink guides 184, and to maintain the concentration of the colorant particles in the ink Q ejected as ink droplets at a predetermined level.

In the ejection head 180 of this embodiment including the control electrodes of the two-layered electrode structure described above, the second control electrodes 190 always receive application of a predetermined voltage (600 V, for instance) and the first control electrodes 188 are switched between a ground state (off-state) and a high-impedance state (on-state) in accordance with image data, for instance. By doing so, ejection/non-ejection of the ink Q (ink droplets R) containing the colorant particles (e.g., pigments) charged to the same polarity as that of the high-voltage applied to the second control electrodes 190 can be controlled. That is, in the ejection head 180, when one of the first control electrodes 188 is set at the ground level (off-state), the electric field strength in the vicinity of the tip end portion 184a of a corresponding ink guide 184 remains low and ejection of the ink Q from the tip end portion 184a of the ink guide 184 is not performed. On the other hand, when one of the first control electrodes 188 is set under the high-impedance state (on-state), the electric field strength in the vicinity of the tip end portion 184a of the corresponding ink guide 184 is increased and the ink Q concentrated in the tip end portion 184a of the ink guide 184 is ejected from the tip end portion 184a by means of an electrostatic force. When doing so, it is also possible to further concentrate the ink Q by selecting the condition.

In such a two-layered electrode structure, the first control electrodes 188 are switched between the high-impedance state and the ground level, so that no large electric power is consumed for the switching. Therefore, according to this embodiment, even in the case of an ink jet head that needs to perform high-definition recording at a high speed, it becomes possible to significantly reduce power consumption.

It should be noted here that the ejection/non-ejection may be controlled by switching the first control electrodes 188 between the ground level (off-state) and the high-voltage level (on-state) in accordance with image data. In the ejection head 180 of this embodiment, when one of the first control electrodes 188 and the second control electrodes 190 are set at the ground level, the ink ejection is not performed and, only when the first control electrodes 188 are set under the high-impedance state or at the high-voltage level and the second control electrodes 190 are set at the high-voltage level, the ink ejection is performed.

Also, in this embodiment, pulse voltages may be applied to the first control electrodes 188 and the second control electrodes 190 in accordance with image signals and the ink ejection may be performed when both of these electrodes are set at the high-voltage level.

It should be noted here that it does not matter whether the ink ejection/non-ejection is controlled using one or both of the first control electrodes 188 and the second control electrodes 190. However, it is preferable that when one of the first control electrodes 188 and the second control electrodes 190 are set at the ground level, no ejection of the ink Q be performed and, only when the first control electrodes 188 are set under the high-impedance state or at the high-voltage level and the second control electrodes 190 are set at the high-voltage level, ink ejection be performed.

Also, the recording medium P may be charged to −1.6 kV, for instance, and the ink ejection may be controlled so that the ink will not be ejected when at least one of the first control electrodes 188 and the second control electrodes 190 are set at a negative high voltage (−600 V, for instance) and the ink will be ejected only when both of the first control electrodes 188 and the second control electrodes 190 are set at the ground level (0V).

Also, according to this embodiment, the ejection portions are arranged in a two-dimensional manner and are matrix-driven, so that it becomes possible to significantly reduce the number of row drivers for driving multiple ejection portions in the row direction and the number of column drivers for driving multiple ejection portions in the column direction. Therefore, according to this embodiment, it becomes possible to significantly reduce the implementation area and power consumption of a circuit for driving the two-dimensionally arranged ejection portions. Also, according to this embodiment, it is possible to arrange the ejection portions while maintaining relatively large margins, so that it becomes possible to extremely reduce a danger of discharging between the ejection portions and to cope with both of high-density implementation and high voltage driving with safety.

It should be noted here that in the case of an ejection head, such as the electrostatic ejection head 180 described above, that uses the control electrodes of the two-layered electrode structure composed of the first control electrodes 188 and the second control electrodes 190, when the ejection portions are arranged at a high density, an electric field interference may occur between adjacent ejection portions. Therefore, it is preferable that, like in this embodiment, the guard electrode 196 be provided between the first control electrodes 188 of adjacent ejection portions so that the guard electrode 196 may shield the ink guides 184 from the electric lines of force to the adjacent ink guides 184.

The guard electrode 196 is arranged in spaces between the first control electrodes 188 of adjacent ejection portions and suppresses the electric field interferences generated between the ink guides 184 of the adjacent ejection portions. FIGS. 5A, 5B, and 5C are respectively cross-sectional views taken along the lines VA-VA, VB-VB, and VC-VC in FIG. 4B. As shown in FIG. 5A, the guard electrode 196 is a sheet-like electrode such as a metal plate that is common to every ejection portion, and holes are bored in the guard electrode 196 in portions corresponding to the first control electrodes 188 provided around the through holes 198 in the two-dimensionally arranged ejection portions (also see FIG. 4A). Note that in this embodiment, the reason why the guard electrode 196 is provided is that if the ejection portions are arranged at a high density, there is a case where an electric field generated by an ejection portion is influenced by the states of electric fields generated by its adjacent ejection portions and therefore the size and drawing position of a dot ejected from the ejection portion fluctuate and recording quality is adversely affected.

By the way, the upper side of the guard electrode 196 shown in FIGS. 4A and 4B is covered with the insulation layer 194c except the through holes 198 and the insulation layer 194b is disposed between the guard electrode 196 and the first control electrodes 188, thereby insulating the electrodes 196 and 188 from each other. That is, the guard electrode 196 is arranged between the insulation layer 194c and the insulation layer 194b and the first control electrodes 188 are arranged between the insulation layer 194b and the insulating substrate 186.

That is, as shown in FIG. 5B, on the upper surface of the insulating substrate 186, that is, between the insulation layer 194b and the insulating substrate 186, the first control electrodes 188 of the respective ejection portions formed around the through holes 198 are two-dimensionally arranged and are connected to each other in the column direction.

Also, as shown in FIG. 5C, on the upper surface of the insulation layer 194a (that is, on the lower surface of the insulating substrate 186), that is, between the insulation layer 194a and the insulating substrate 186 (see FIG. 4A), the second control electrodes 190 formed around the through holes 198 of the respective ejection portions are two-dimensionally arranged. Also, the second control electrodes 190 in the row direction are connected to each other.

Also, in this embodiment, for example, in order to shield from a repulsive electric field from the control electrodes of each ejection portion (each first control electrode 188 and each second control electrode 190) toward the ink flow path 199, a shield electrode may be provided on the flow path side of the first and second control electrodes 188 and 190.

Further, in the ejection head 180 of this embodiment, the floating conduction plate 192 is provided which constitutes the undersurface of the ink flow path 199 and causes the positively charged colorant particles (charged colorant particles) in the ink flow path 199 to migrate upwardly (that is, toward the recording medium P side) by means of induced voltages constantly generated by pulse voltages applied to the first control electrodes 188 and the second control electrodes 190. Also, an electrically insulating coating film (not shown) is formed on a surface of the floating conduction plate 192, thereby preventing a situation where the physical properties and components of the ink are destabilized due to charge injection into the ink or the like. It is preferable that the electric resistance of the insulating coating film be set at 10¹² Ω·cm or higher, more preferably at 10¹³ Ω·cm or higher. Also, it is preferable that the insulating coating film be corrosion resistant to the ink, thereby preventing a situation where the floating conduction plate 192 is corroded by the ink. Further, the floating conduction plate 192 is covered with an insulation member from its bottom side. With this construction, the floating conduction plate 192 is completely electrically insulated and floated.

Here, at least one floating conduction plate 192 is provided for each unit of the ejection head. When four ejection heads are used for C, M, Y, and K for instance, each head is provided with at least one floating conduction plate and the ejection heads for C and M will never share the same floating conduction plate.

In this embodiment, the circular electrodes are provided as the first control electrodes 188 and the second control electrodes 190 of the respective ejection portions, and the first control electrodes 188 and the second control electrodes 190 are connected to each other in the row direction and the column direction, respectively. However, the present invention is not limited to this and all of the ejection portions may be separated from each other and driven independently of each other. Alternatively, one of the first control electrodes 188 and the second control electrodes 190 may be set as a sheet-like electrode common to every ejection portion (holes are bored in portions corresponding to the through holes 198).

Also, in this embodiment, the control electrodes are arranged so as to form the two-layered electrode structure composed of the first control electrodes 188 and the second control electrodes 190. However, the present invention is not limited to this and the control electrodes may be arranged so as to form a mono-layered electrode structure. In the case of the mono-layered electrode structure, it does not matter on which surface of the insulating substrate 186 the control electrodes are arranged, however, it is preferable that the control electrodes be provided on the recording medium P side thereof. The ejection head for each color is constructed as described above.

Each ejection head is disposed so that the direction of arrangement of its ejection portions coincides with the direction perpendicular to the direction of conveyance of the recording medium P. The ejection head for each color is disposed side by side along the direction of conveyance of the recording medium P. Each ejection head is disposed so that the ejection portions of the ejection head are opposed to the surface of the conveyor belt 132 in a position where the conductive platen 136 is disposed and are at a predetermined distance away from the surface of the recording medium P which is conveyed with the recording medium P being electrostatically attracted to the conveyor belt 38.

The ejection portions of each ejection head may be disposed in a direction substantially parallel to the direction of conveyance of the recording medium P. In this case, there is carried out the serial scanning in which it is repeated that the ink is ejected while the main scanning with the ejection head is carried out in the direction perpendicular to the direction of conveyance of the recording medium P, and the recording medium P is then conveyed by a fixed amount.

As described above, the surface of the recording medium P which is electrostatically attracted to the conveyor belt 132 acting as the counter electrode is uniformly charged to a predetermined negative high potential by the charger 138a for the recording medium P, and hence is in a state in which a constant D.C. bias voltage (about −1.5 kV) is always applied thereto. In addition, in recording of an image, the pulse voltages corresponding to the image data are applied to the first and second control electrodes 188 and 190 of each of the ejection portions of the ejection head for each color by a pulse voltage applying device (not shown) for application of pulse voltages to the ink jet head 156.

When the high voltages (400 to 600 V) are respectively applied as the pulse voltages to the first and second control electrodes 188 and 190 of each of the ejection portions of the ejection head for each color, in a state in which the constant D.C. bias voltage (about −1.5 kV) is applied to the surface of the recording medium P, the ink is ejected, while when the low voltages (0 V) are applied, no ink is ejected in that state. The ink ejected from the ejection head for each color is attracted towards the surface of the recording medium P having the bias voltage applied thereto and adheres to the surface of the recording medium P, thereby recording a full-color image corresponding to the image data on the surface of the recording medium P.

When the recording medium P is charged to a bias voltage (opposite in polarity to the colorant particles), an attractive force that attracts the colorant particles from the through hole toward the tip end portion of the ink guide acts on the positively charged colorant particles in the ink and the colorant particles are concentrated with a high degree of efficiency in the tip end portion of the ink guide. When a pulse voltage is applied to the control electrodes, the colorant particles are further concentrated in the tip end portion of the ink guide and ejected in the form of ink droplets.

Note that, in this embodiment, the constant D.C. bias voltage is always applied to the surface of the recording medium P which is electrostatically attracted to the conveyor belt 132 acting as the counter electrode, and in recording of an image, the pulse voltages corresponding to the image data are applied to the control electrodes. However, it may also be adapted that the counter electrode side is grounded, and in this state, a constant D.C. bias voltage (e.g., 1.5 kV) is always applied to the side of the control electrodes of each of the ejection portions of the ejection head for each color by a D.C. bias voltage applying device for application of a bias voltage to the ink jet head 156.

Ink Q (ink composition) used in the ink jet recording apparatus 100 of the embodiment is obtained by dispersing colorant particles (charged fine particles which contain colorants) in a carrier liquid.

The carrier liquid is preferably a dielectric liquid (non-aqueous solvent) having a high electrical resistivity (equal to or larger than 10⁹ Ω·cm, and more preferably equal to or larger than 10¹⁰ Ω·cm). If the electrical resistance of the carrier liquid is low, the concentration of the colorant particles does not occur since the carrier liquid receives the injection of the electric charges and is charged due to a drive voltage applied to the control electrodes. In addition, since there is also anxiety that the carrier liquid having a low electrical resistance causes the electrical conduction between the adjacent control electrodes, the carrier liquid having a low electrical resistance is unsuitable for the present invention.

The relative permittivity of the dielectric liquid used as the carrier liquid is preferably equal to or smaller than 5, more preferably equal to or smaller than 4, and much more preferably equal to or smaller than 3.5. Such a range is selected for the relative permittivity, whereby the electric field effectively acts on the colorant particles contained in the carrier liquid to facilitate the electrophoresis of the colorant particles.

Note that the upper limit of the specific electrical resistance of such a carrier liquid is desirably about 10¹⁶ Ω·cm, and the lower limit of the relative permittivity is desirably about 1.9. The reason why the electrical resistance of the carrier liquid preferably falls within the above-mentioned range is that if the electrical resistance becomes low, then the ejection of the ink under a low electric field becomes worse. Also, the reason why the relative permittivity preferably falls within the above-mentioned range is that if the relative permittivity becomes high, then the electric field is relaxed due to the polarization of the solvent, and as a result the color of dots formed under this condition becomes light, or the bleeding occurs.

Preferred examples of the dielectric liquid used as a carrier liquid include straight-chain or branched aliphatic hydrocarbons, alicyclic hydrocarbons, aromatic hydrocarbons, and the same hydrocarbons substituted with halogens. Specific examples thereof include hexane, heptane, octane, isooctane, decane, isodecane, decalin, nonane, dodecane, isododecane, cyclohexane, cyclooctane, cyclodecane, benzene, toluene, xylene, mesitylene, Isopar C, Isopar E, Isopar G, Isopar H, Isopar L, Isopar M (Isopar: a trade name of EXXON Corporation), Shellsol 70, Shellsol 71 (Shellsol: a trade name of Shell Oil Company), AMSCO OMS, AMSCO 460 Solvent, (AMSCO: a trade name of Spirits Co., Ltd.), a silicone oil (such as KF-96L, available from Shin-Etsu Chemical Co., Ltd.). The dielectric liquid may be used singly or as a mixture of two or more thereof.

For such colorant particles dispersed in the carrier liquid, colorants themselves may be dispersed as the colorant particles into the carrier liquid, but dispersion resin particles are preferably contained for enhancement of fixing property. In the case where the dispersion resin particles are contained in the carrier liquid, in general, there is adopted a method in which pigments are covered with the resin material of the dispersion resin particles to obtain particles covered with the resin, or the dispersion resin particles are colored with dyes to obtain the colored particles.

As the colorants, pigments and dyes conventionally used in ink compositions for ink jet recording, (oily) ink compositions for printing, or liquid developers for electrostatic photography may be used.

Pigments used as colorants may be inorganic pigments or organic pigments commonly employed in the field of printing technology. Specific examples thereof include but are not particularly limited to known pigments such as carbon black, cadmium red, molybdenum red, chrome yellow, cadmium yellow, titanium yellow, chromium oxide, viridian, cobalt green, ultramarine blue, Prussian blue, cobalt blue, azo pigments, phthalocyanine pigments, quinacridone pigments, isoindolinone pigments, dioxazine pigments, threne pigments, perylene pigments, perinone pigments, thioindigo pigments, quinophthalone pigments, and metal complex pigments.

Preferred examples of dyes used as colorants include oil-soluble dyes such as azo dyes, metal complex salt dyes, naphthol dyes, anthraquinone dyes, indigo dyes, carbonium dyes, quinoneimine dyes, xanthene dyes, aniline dyes, quinoline dyes, nitro dyes, nitroso dyes, benzoquinone dyes, naphthoquinone dyes, phthalocyanine dyes, and metal phthalocyanine dyes.

Further, examples of dispersion resin particles include rosins, rosin-modified phenol resin, alkyd resin, a (meth)acryl polymer, polyurethane, polyester, polyamide, polyethylene, polybutadiene, polystyrene, polyvinyl acetate, acetal-modified polyvinyl alcohol, and polycarbonate.

Of those, from the viewpoint of ease for particle formation, a polymer having a weight average molecular weight in a range of 2,000 to 1,000,000 and a polydispersity (weight average molecular weight/number average molecular weight) in a range of 1.0 to 5.0 is preferred. Moreover, from the viewpoint of ease for the fixation, a polymer in which one of a softening point, a glass transition point, and a melting point is in a range of 40° C. to 120° C. is preferred.

In the ink Q, the content of colorant particles (total content of colorant particles and dispersion resin particles) preferably falls within a range of 0.5 to 30.0 wt % for the overall ink, more preferably falls within a range of 1.5 to 25.0 wt %, and much more preferably falls within a range of 3.0 to 20.0 wt %. If the content of colorant particles decreases, the following problems become easy to arise. The density of the printed image is insufficient, the affinity between the ink Q and the surface of the recording medium P becomes difficult to obtain to prevent the image firmly stuck to the surface of the recording medium P from being obtained, and so forth. On the other hand, if the content of colorant particles increases, problems occur in that the uniform dispersion liquid becomes difficult to obtain, the clogging of the ink Q is easy to occur in the ink jet head or the like to make it difficult to obtain the stable ink ejection, and so forth.

In addition, the average particle diameter of the colorant particles dispersed in the carrier liquid preferably falls within a range of 0.1 to 5.0 μm, more preferably falls within a range of 0.2 to 1.5 μm, and much more preferably falls within a range of 0.4 to 1.0 μm. Those particle diameters are measured with CAPA-500 (a trade name of a measuring apparatus manufactured by HORIBA Ltd.).

After the colorant particles and optionally a dispersing agent are dispersed in the carrier liquid, a charging control agent is added to the resultant carrier liquid to charge the colorant particles, and the charged colorant particles are dispersed in the resultant liquid to thereby produce the ink Q. Note that in dispersing the colorant particles in the carrier liquid, a dispersion medium may be added if necessary.

As the charging control agent, for example, various ones used in the electrophotographic liquid developer can be utilized. In addition, it is also possible to utilize various charging control agents described in “DEVELOPMENT AND PRACTICAL APPLICATION OF RECENT ELECTRONIC PHOTOGRAPH DEVELOPING SYSTEM AND TONER MATERIALS”, pp. 139 to 148; “ELECTROPHOTOGRAPHY-BASES AND APPLICATIONS”, edited by THE IMAGING SOCIETY OF JAPAN, and published by CORONA PUBLISHING CO. LTD., pp. 497 to 505, 1988; and “ELECTRONIC PHOTOGRAPHY” by Yuji Harasaki, 16(No. 2), p. 44, 1977.

Note that the colorant particles may be positively or negatively charged as long as the charged colorant particles are identical in polarity to the drive voltages applied to control electrodes.

In addition, the charging amount of colorant particles is preferably in a range of 5 to 200 μC/g, more preferably in a range of 10 to 150 μC/g, and much more preferably in a range of 15 to 100 μC/g.

In addition, the electrical resistance of the dielectric liquid may be changed by adding the charging control agent in some cases. Thus, a distribution factor P defined below is preferably equal to or larger than 50%, more preferably equal to or larger than 60%, and much more preferably equal to or larger than 70%.
P=100×(σ1−σ2)/σ1
where σ1 is an electric conductivity of the ink Q, and σ2 is an electric conductivity of a supernatant liquid which is obtained by inspecting the ink Q with a centrifugal separator. Those electric conductivities were obtained by measuring the electric conductivities of the ink and the supernatant liquid under a condition of an applied voltage of 5 V and a frequency of 1 kHz using an LCR meter of an AG-4311 type (manufactured by ANDO ELECTRIC CO., LTD.) and electrode for liquid of an LP-05 type (manufactured by KAWAGUCHI ELECTRIC WORKS, CO., LTD.). In addition, the centrifugation was carried out for 30 minutes under a condition of a rotational speed of 14,500 rpm and a temperature of 23° C. using a miniature high speed cooling centrifugal machine of an SRX-201 type (manufactured by TOMY SEIKO CO., LTD.).

The ink Q as described above is used, which results in that the colorant particles are likely to migrate and hence the colorant particles are easily concentrated.

The electric conductivity of the ink Q is preferably in a range of 100 to 3,000 pS/cm, more preferably in a range of 150 to 2,500 pS/cm, and much more preferably in a range of 200 to 2,000 pS/cm. The range of the electric conductivity as described above is set, resulting in that the applied voltages to the control electrodes are not excessively high, and also there is no anxiety to cause the electrical conduction between the adjacent control electrodes.

In addition, the surface tension of the ink Q is preferably in a range of 15 to 50 mN/m, more preferably in a range of 15.5 to 45.0 mN/m, and much more preferably in a range of 16 to 40 mN/m. The surface tension is set in this range, resulting in that the applied voltages to the control electrodes are not excessively high, and also the ink does not leak or spread to the periphery of the head to contaminate the head.

Moreover, the viscosity of the ink Q is preferably in a range of 0.5 to 5.0 mPa·sec, more preferably in a range of 0.6 to 3.0 mPa·sec, and much more preferably in a range of 0.7 to 2.0 mPa·sec.

The ink Q can be prepared for example by dispersing colorant particles into a carrier liquid to form particles and adding a charging control agent to the dispersion medium to allow the colorant particles to be charged. The following methods are given as the specific methods.

(1) A method including: previously mixing (kneading) a colorant and optionally dispersion resin particles; dispersing the resultant mixture into a carrier liquid using a dispersing agent when necessary; and adding the charging control agent thereto.

(2) A method including: adding a colorant and optionally dispersion resin particles and a dispersing agent into a carrier liquid at the same time for dispersion; and adding the charging control agent thereto.

(3) A method including adding a colorant and the charging control agent and optionally the dispersion resin particles and the dispersing agent into a carrier liquid at the same time for dispersion.

Note that, in this embodiment, there is not adopted the process in which a force is caused to act on the overall ink to fly the ink towards the recording medium as in a conventional ink jet system, but there is adopted the process in which a force is caused to mainly act on the colorant particles as the solid components dispersed into the carrier liquid to fly the ink droplets to the recording medium P.

As a result, an image can be recorded on various recording media such as a non-absorption film (such as a PET film) as well as plain paper. In addition, a high-quality image can be obtained on the various recording media without causing bleeding or flowing on the recording medium P.

Such ink is supplied to the ink jet head 156 by the ink circulation system 160.

The ink circulation system 160 includes an ink tank 164, a pump (not shown), an ink supply and collection path 166. The ink tank 164 is placed on a bottom surface inside the housing 122, and connected to the ink jet head 156 via the ink supply and collection path 166.

In the ink tank 164, ink of four colors containing colorant particles of respective colors and a dispersion solvent for dispersing the colorant particles is held. The ink of each color in the ink tank 164 is supplied to an ejection head of each color of the ink jet head 156 via the supply path of ink by the pump. Furthermore, excessive ink of each color that has not been used for recording an image is collected in the ink tank 164 of each color via the collection path of ink by the pump.

The position detecting device 162 of the recording medium P is conventionally known position detecting means such as a photosensor, and is placed at a position that is between the conveyor roll 131a and the charging device 138a on the conveying path of the recording medium P and opposed to the surface of the conveyor belt 132 by which the recording medium P is conveyed.

The position of the recording medium P is detected by the position detecting device 162, and the positional information is supplied to a head driver 158.

The head driver 158 is attached to the upper portion in FIG. 2 inside the housing 122, and connected to the ink jet head 156.

The head driver 158 receives image data from an external apparatus, and receives positional information on the recording medium P from the position detecting device 162. Owing to the control of the head driver 158, in accordance with the positional information on the recording medium P, ink of each color is ejected from the ejection head of each color in accordance with the image data while the ejection timing of the ejection head of each color of the ink jet head 156 is being controlled, whereby a full-color image corresponding to the image data is recorded on the recording medium P.

More specifically, while the recording medium P is being conveyed at a predetermined constant speed below the ink jet head 156 by the conveying means 114, printing of four colors is performed on the surface of the recording medium P to record a full-color image thereon by the recording means 116.

Next, the solvent collecting means 118 will be described.

The solvent collecting means 118 is placed on the left side of the upper portion inside the housing 122, and collects a dispersion solvent evaporating from ink ejected from the ink jet head 156 to the recording medium P, a dispersion solvent evaporating from ink during fixation of an image, and the like. The solvent collecting means 118 includes a discharge fan 170, an activated carbon filter 172, a cooling device (not shown) and the like.

The air containing a dispersion solvent component in the housing 122 is cooled by the cooling device to have its solvent component coagulated, and discharged out of the housing 122 via the activated carbon filter. At this time, the solvent component coagulated by the cooling device is re-used, or stored in a waste liquid tank (not shown).

Furthermore, the air containing a dispersion solvent component in the housing 122 is discharged out of the housing 122 via the activated carbon filter 172 by the discharge fan 170. At this time, the dispersion solvent component contained in the air inside the housing 122 is adsorbed to be removed by the activated carbon filter 172.

Hereinafter, the operation of the recording apparatus 100 will be described.

In the recording apparatus 100, during recording of an image, the recording medium P stored in the sheet feed tray 124 is taken out one by one by the feed roll 126, nipped between the conveyor roll 131a and the conveyor belt 132, and conveyed to a predetermined position on the conveyor belt 132.

The recording medium P conveyed to the predetermined position on the conveyor belt 132 is charged with a bias voltage to a negative high potential by the charging device 138a, and electrostatically attracted to the surface of the conveyor belt 132.

While the recording medium P electrostatically attracted to the surface of the conveyor belt 132 is being moved at a predetermined constant speed in synchronization with the movement of the conveyor belt 132, an image corresponding to image data is recorded on the surface of the recording medium P by the ink jet head 156.

While the recording medium P with one surface recorded is being nipped and conveyed by the fixing roll pair 20 in a state of electrostatic attraction to the conveyor belt 132, the recorded image is fixed by heating.

After that, the recording medium P is subjected to static elimination by the static elimination device 140, and the recording medium P becomes likely to be separated from the conveyor belt 132.

In the case where the recording on only one surface is instructed, the recording medium P with one surface recorded is conveyed along the guide 144b by the conveyor belt 132 in accordance with the switching claw 143 set at the discharge position, further nipped and conveyed between the conveyor roll 131b and the guide 144b, discharged from the discharge part and, successively stacked and thus stocked in the discharge tray 128.

In contrast, in the case where the recording on both surfaces is instructed, the recording medium P with one surface recorded is conveyed to the inversion roll pair 147 side by the conveyor belt 132 in accordance with the switching claw 143 set at the inversion position. After that, the rotation of the inversion roll pair 147 is reversed, the recording medium P is conveyed along the guide 144c, further nipped and conveyed between the conveyor belt 132 and the guide 144c, and supplied to a predetermined position on the conveyor belt 132. More specifically, the recording medium P is inverted at this stage.

After that, the inverted recording medium P is moved in synchronization with the movement of the conveyor belt 132, and similarly, an image corresponding to image data is recorded on the reverse surface. The operation after this is the same as that in the case where the recording on only one surface is instructed.

Next, the ink jet recording apparatus of the present invention will be described by way of another embodiment.

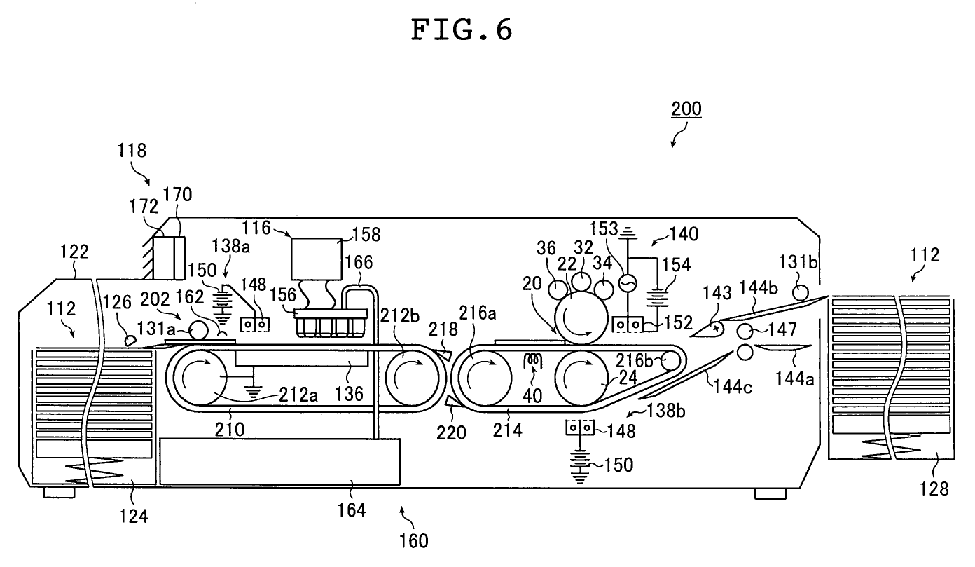

FIG. 6 is a schematic view showing a configuration of a second embodiment of an electrostatic ink jet recording apparatus using the fixing device 10. An electrostatic ink jet recording apparatus 200 shown in FIG. 6 has the same configuration as that of the recording apparatus 100 shown in FIG. 1 except for a conveying means 202. Thus, the same components shown in FIG. 1 are denoted by the same reference numerals, and the detailed description thereof is omitted. Hereinafter, the points specific to the ink jet recording apparatus 200 will be described mainly.

The conveying means 202 of this embodiment conveys the recording medium P in a predetermined path from the sheet feed tray 124 to the discharge tray 128, and includes the conveyor rolls 131a and 131b, the heating means 40, the conductive platen 136, the charging devices 138a and 138b, the static elimination device 140, the switching claw 143, the guides 144a, 144b, and 144c, the inversion roll pair 147, and the fixing roll pair 20 which are the same components as those in the above embodiment, and a first conveyor belt 210, a second conveyor belt 214, belt rolls 212a, 212b, 216a, and 216b, and separation claws 218 and 220 which are components specific to this embodiment.

The first conveyor belt 210 is an endless belt, and stretched in an oval shape around the two belt rolls 212a and 212b. The surface (outer surface) side of the first conveyor belt 210 to which the recording medium P is electrostatically attracted is insulative, and a reverse surface (inner surface) thereof is conductive.

Furthermore, at the position opposed to the surface of the first conveyor belt 210, the conveyor roll 131a, the charging device 138a, the recording means 116, and the separation claw 218 are placed successively from an upstream side of the conveying path of the recording medium P. Furthermore, on an inner side of the conveyor belt 210 placed at a position opposed to the recording means 116, the conductive platen is placed.

One of the belt rolls 212a and 212b is connected to a driving source (not shown) in the same way as in the above-mentioned belt roll, and during recording, rotates at a predetermined speed, and the recording medium P electrostatically attracted to the first conveyor belt 210 is also conveyed in the same direction.

The recording medium P, which is charged on the first conveyor belt 210 and on which an image is recorded, is separated from the first conveyor belt 210 by the separation claw 218 on the most downstream side of the conveying path of the recording medium P on the first conveyor belt 210.

The second conveyor belt 214 is an endless belt, and stretched in an oval shape around the two belt rolls 216a and 216b. The second conveyor belt 214 is placed on a downstream side of the first conveyor belt 210 on the conveying path of the recording medium P to be adjacent thereto.

On the conveying path of the recording medium P of the second conveyor belt 214, the fixing roll pair 20 is placed, and on an inner side of the second conveyor belt 214 between the belt roll 216a and the fixing roll 24 on the conveying path of the recording medium P, the heating means 40 is placed.

The static elimination device 140, the switching claw 143, the inversion roll pair 147, and the guides 144a, 144b, and 144c are placed in the same way as in the above embodiment on a downstream side of the fixing roll pair 20 on the conveying path of the recording medium P. Herein, in the case of the recording on only one surface and in the case of the recording on both surfaces, the recording medium with an image fixed thereon is conveyed in the same way as in the above embodiment. Therefore, the detailed description thereof is omitted.

Furthermore, the charging device 138b is placed on a downstream side of the guide 144c on the conveying path during inversion of the recording medium P, and the separation claw 220 is placed on the most downstream side of the conveying path during inversion of the recording medium P of the second conveyor belt 214.

The recording medium P separated from the first conveyor belt 210 by the separation claw 218 is supplied to the second conveyor belt 214. Herein, the second conveyor belt 214 has a surface charged to a predetermined potential by the charging device 138b. Because of this, the recording medium P supplied to the second conveyor belt 214 and the second conveyor belt 214 electrostatically attract each other.

Thus, in this embodiment, the charging device 138b has a function of the charging means 38 of the fixing device 10, and the second conveyor belt 214 has a function of the sticking member 30 of the fixing device 10.

The recording medium P is nipped and conveyed by the fixing roll pair 20 together with the second conveyor belt 214 in a state of electrostatic attraction to the second conveyor belt 214, whereby an image is fixed.

Furthermore, the recording medium P conveyed to the most downstream side of the second conveyor belt 214 on the conveying path during inversion of the recording medium P is peeled from the second conveyor belt 214 by the separation claw 220, supplied to the first conveyor belt 210, and electrostatically attracted to the first conveyor belt 210.

Thus, in this embodiment, the conveyor belt on which recording is performed onto the recording medium by the recording means and the sticking member for fixing an image are separated from each other, whereby the vibration generated when the fixing roll pair nips and conveys an image recording sheet during recording can be prevented from being transmitted to the recording medium on which an image is being recorded. Therefore, an image can be formed preferably even in the case of, for example, drawing a high-definition image.

The present invention is not limited to the above embodiment, and is applicable to conventionally known various kinds of electrostatic ink jet recording apparatuses. More specifically, the specific configuration of each of the holding means, the conveying means and the recording means for the recording medium P, and the solvent collecting means constituting the electrostatic ink jet recording apparatus to which the present invention is applied is not limited to that in the embodiments shown in the figures.

Furthermore, in the above embodiments, the ink jet recording apparatus recording on both surfaces has been described, but the present invention is not limited thereto, and an ink jet recording apparatus recording on one surface may be used.

The present invention is basically as described above.

The fixing method and fixing device of the present invention have been described in detail; however, the present invention is not limited to the above embodiments, and it should be appreciated that the present invention may be variously altered or changed within a range not exceeding the spirit of the present invention.

### EXAMPLES

Hereinafter, the present invention will be described in more detail by way of specific examples.

### Example 1

In this specific example, the fixing device 10 having the configuration shown below was used.

The fixing roll 22 having the following configuration was used. The heater 26 was placed as a heating source at the center, the core material 22a was made of cylindrical aluminum to be a cored bar with a diameter of 54 mm and a thickness of 10 mm, the elastic layer 22b was made of silicone rubber, for example, with a rubber hardness of JIS A 10, a thickness of 3 mm, and a surface roughness Ra of 10 μm, the intermediate layer 22c was made of fluoro rubber with a rubber hardness of JIS A 70, a thickness of 50 μm, and a surface roughness Ra of 0.2 μm, and the coat layer 22d was made of silicone rubber with a rubber hardness of JIS A 60, a thickness of 50 μm, and a surface roughness Ra of 0.1 μm.

The fixing roll 24 having the following configuration was used. The heater 26 was placed as a heating source at the center, the core material 24a was made of cylindrical aluminum to be a cored bar with a diameter of 56 mm and a thickness of 10 mm, the elastic layer 22b was made of silicone rubber with predetermined rubber hardness and thickness (e.g., rubber hardness: JIS A 20, thickness: 2 mm), and the coat layer was made of resin with a predetermined thickness and a predetermined surface roughness (e.g., perfluoroalkoxy resin (PFA) with a thickness of 50 μm and a surface roughness Ra of 0.2 μm).

Next, the sticking member 30 having the following configuration was used. The conductive layer was made of an iron plate with a thickness of 0.1 mm, and the insulating layer was made of heat-resistant polyimide resin with a thickness of 50 μm.

Each of three kinds of A4-size art paper each having a thickness of 70 μm, 100 μm, or 150 μm (Tokubishi Art, produced by Mitsubishi Paper Mills Co., Ltd.) was used as the recording medium P.

An ink jet head was used to form an image with cyan ink having a thickness of 1.0 g/m² on the recording medium P. Furthermore, the sticking member 30 of the fixing device 10 was charged to −2.0 kV, and the recording medium with the image formed thereon being unfixed was placed on the sticking member 30. The sticking member 30 and the recording medium P were allowed to electrostatically attract each other. At an interval of 5 seconds to 5 minutes from the formation of the image, the recording medium P was inserted in the fixing roll pair 20 together with the sticking member 30, whereby the image was fixed.

The nip pressure between the fixing rolls 22 and 24 was 0.3 MPa. The conveying speed of the recording medium P was 10 mm/sec. The surface temperature of each of the fixing rolls 22 and 24 was 120° C.

Thus, regarding the recording media with three kinds of thicknesses (70 μm, 100 μm, 150 μm), an image was fixed by the fixing device 10 a predetermined number of times on the recording medium with the image recorded thereon under the above condition, and the probability with which the winding of the recording medium around the fixing roll 22 would occur was measured. Consequently, in the case of the recording medium with a thickness of 150 μm, the winding did not occur. In the case of the recording medium with a thickness of 100 μm, the occurrence ratio of the winding was 25%. In the case of the recording medium with a thickness of 70 μm, the occurrence ratio of the winding was 70%.

### Comparative Example 1

An image was fixed on a recording medium by the same method as that of Example 1, except that the sticking member 30 was not charged, and the recording medium P and the sticking member 30 were not allowed to electrostatically attract each other. Consequently, in the case of the recording medium with a thickness of 150 μm, the occurrence ratio of the winding was 20%. In the case of the recording medium with a thickness of 100 μm, the occurrence ratio of the winding was 60%. In the case of the recording medium with a thickness of 70 μm, the occurrence ratio of the winding was 100%.

Table 1 shows the summary of the occurrence ratio of the winding for each thickness (paper thickness) of the recording medium.

TABLE 1

| | | Example 1 | Comparative Example 1 |
|---|---|---|---|
| Paper | 150 μm | 0% | 20% |
| thickness | 100 μm | 25% | 60% |
| | 70 μm | 70% | 100% |

As shown in Table 1, the occurrence ratio of the winding around the fixing roll can be reduced by allowing the recording medium and the sticking member to electrostatically attract each other, and inserting the recording medium in the fixing roll pair together with the sticking member to fix an image.

Furthermore, the winding occurs with a higher probability as the temperature at which the recording medium is heated during fixing is higher, the nip pressure is larger, and the recording medium is thinner.

### Example 2

An image was fixed on a recording medium by the same method as that of Example 1, except that the release agent applying means 32 was used for the fixing roll 22 during fixation, and silicone oil (dynamic viscosity: 100 mm²/sec, produced by Shin-Etsu Silicones) as a release agent was applied to such a degree that silicone oil was seen slightly at a nip portion, i.e., a contact portion between the sticking member 30 and the fixing roll 22. Consequently, in the case of the recording medium with a thickness of 150 μm, the occurrence ratio of the winding was 0%. In the case of the recording medium with a thickness of 100 μM, the occurrence ratio of the winding was 0%. In the case of the recording medium with a thickness of 70 μm, the occurrence ratio of the winding was 2%.

### Comparative Example 2

An image was fixed on a recording medium by the same method as that of Example 2, except that the sticking member 30 was not charged, and the recording medium P and the sticking member 30 were not allowed to electrostatically attract each other. Consequently, in the case of the recording medium with a thickness of 150 μm, the occurrence ratio of the winding was 0%. In the case of the recording medium with a thickness of 100 μm, the occurrence ratio of the winding was 9%. In the case of the recording medium with a thickness of 70 μm, the occurrence ratio of the winding was 53%.

Table 2 shows the summary of the occurrence ratio of the winding for each thickness (paper thickness) of the recording medium.

TABLE 2

| | | Example 2 | Comparative Example 2 |
|---|---|---|---|
| Paper | 150 μm | 0% | 0% |
| thickness | 100 μm | 0% | 9% |
| | 70 μm | 0% | 53% |

As shown in Table 2, the occurrence ratio of the winding around the fixing roll can be reduced by allowing the recording medium and the sticking member to electrostatically attract each other, and inserting the recording medium in the fixing roll pair together with the sticking member to fix an image.

Furthermore, by applying the release agent to the fixing roll, the occurrence ratio of the winding can be reduced reliably.

### Example 3

An image was fixed on a recording medium by the same method as that of Example 1, except that the potential of the surface of the fixing roll was set to be about 0 by the static elimination means 36. Consequently, in the case of the recording medium with a thickness of 150 μm, the occurrence ratio of the winding was 0%. In the case of the recording medium with a thickness of 100 μm, the occurrence ratio of the winding was 5%. In the case of the recording medium with a thickness of 70 μm, the occurrence ratio of the winding was 17%.

### Comparative Example 3

An image was fixed on a recording medium by the same method as that of Example 3, except that the sticking member 30 was not charged, and the recording medium P and the sticking member 30 were not allowed to electrostatically attract each other. Consequently, in the case of the recording medium with a thickness of 150 μm, the occurrence ratio of the winding was 14%. In the case of the recording medium with a thickness of 100 μm, the occurrence ratio of the winding was 44%. In the case of the recording medium with a thickness of 70 μm, the occurrence ratio of the winding was 83%.

Table 3 shows the summary of the occurrence ratio of the winding for each thickness (paper thickness) of the recording medium.

TABLE 3

| | | Example 3 | Comparative Example 3 |
|---|---|---|---|
| Paper | 150 μm | 0% | 14% |
| thickness | 100 μm | 5% | 44% |
| | 70 μm | 17% | 83% |

As shown in Table 3, the occurrence ratio of the winding around the fixing roll can be reduced by allowing the recording medium and the sticking member to electrostatically attract each other, and inserting the recording medium in the fixing roll pair together with the sticking member to fix an image.

Furthermore, by performing static elimination on the surface of the fixing roll, the winding of the recording medium can be further reduced.

The effects of the present invention are apparent from Tables 1, 2, and 3.

What is claimed is:

1. A fixing method for fixing an image drawn on a recording medium using colorant particles containing at least a colorant and a resin on said recording medium, comprising:
using a fixing roll pair composed of a pair of fixing rolls at least one of which is a heating roll;
charging at least one of said recording medium and a sticking member for fastening said recording medium;
electrostatically attracting said recording medium and said sticking member; and
nipping said recording medium and said sticking member attracted each other between said pair of fixing rolls of said fixing roll pair and conveying said recording medium with said image drawn thereon together with said sticking member by means of said fixing roll pair, thereby fixing said image on said recording medium.

2. The fixing method according to claim 1, further comprising:
applying a release agent to a surface of a fixing roll of said fixing roll pair, which comes into contact with said recording medium, wherein
said recording medium with said image drawn thereon is nipped and conveyed together with said sticking member by said fixing roll pair, to thereby fix said image on said recording medium.

3. The fixing method according to claim 1, further comprising:
subjecting a surface of a fixing roll of said fixing roll pair, which comes into contact with the recording medium, to electrostatic elimination, wherein
said recording medium with the image drawn thereon is nipped and conveyed together with said sticking member by said fixing roll pair, to thereby fix said image on said recording medium.

4. The fixing method according to claim 1, wherein said sticking member includes an insulating layer constituting a contact surface side with respect to said recording medium, and a conductive layer provided on an opposite side of said contact surface of said insulating layer with respect to said recording medium.

5. The fixing method according to claim 1, further comprising:
heating said sticking member at a predetermined temperature on an upstream side of said fixing roll pair in a conveying direction of said recording medium, wherein
said recording medium with said image drawn thereon is nipped and conveyed together with said sticking member by said fixing roll pair, to thereby fix said image on said recording medium.

6. A fixing device for fixing an image drawn on a recording medium using colorant particles containing at least a colorant and a resin on said recording medium, comprising:
a fixing roll pair composed of a pair of fixing rolls at least one of which is a heating roll;
a sticking member for fastening said recording medium; and
charging means for charging at least one of said recording medium and said sticking member, wherein
said sticking member and said recording medium with said image drawn thereon are electrostatically attracted, and
said recording medium and said sticking member attracted each other are nipped between said pair of fixing rolls of said fixing roll pair and said recording medium is conveyed together with said sticking member by said fixing roll pair, to thereby fix said image on said recording medium.

7. The fixing device according to claim 6, further comprising:
release agent applying means for applying a release agent to a fixing roll of said fixing roll pair that comes into contact with said recording medium.

8. The fixing device according to claim 6, further comprising:
electrostatic elimination means for performing electrostatic elimination on a surface of a fixing roll of said fixing roll pair that comes into contact with said recording medium.

9. The fixing device according to claim 6, wherein said sticking member includes an insulating layer constituting a contact surface with respect to said recording medium and a conductive layer provided on a surface opposite to said contact surface of said insulating layer with respect to said recording medium.

10. The fixing device according to claim 6, wherein said image on said recording medium is drawn by electrostatic ink jet drawing means using ink in which charged colorant particles are dispersed in a solvent, said electrostatic ink jet drawing means being provided on an upstream side in a conveying direction of said recording medium.

11. The fixing device according to claim 6, further comprising:
heating means for heating said sticking member at a predetermined temperature, said heating means being provided on an upstream side of said fixing roll pair in a conveying direction of said recording medium.
